(19) United States
(12) Patent Application Publication
(10) Pub. No.: US 2015/0261767 A1
(43) Pub. Date: Sep. 17, 2015

(54) SYSTEM AND METHOD FOR THE DATA MANAGEMENT FOR THE ANALYSIS OF DIVERSE, MULTI-STRUCTURED DATA FROM DIVERSE SOURCES

(71) Applicant: SlamData, Inc., Arvada, CO (US)

(72) Inventor: John A. De Goes, Boulder, CO (US)

(21) Appl. No.: 14/659,284

(22) Filed: Mar. 16, 2015

Related U.S. Application Data
(60) Provisional application No. 61/954,260, filed on Mar. 17, 2014.

(51) Int. Cl. G06F 17/30; G06F 21/62

(52) U.S. Cl. CPC G06F 17/30082; G06F 21/6218; G06F 17/30303

(57) ABSTRACT

There is disclosed in an embodiment for management of data for analysis of diverse, multi-structured data from diverse sources importation of data having existing data specifications from an external system. Permissions associated with the data and data policies intrinsic to the data are enforced and any tainted data is untainted by ascribing missing specified properties to the data. The properties for the data that were tainted are recorded and properties of resulting untainted data are encoded as composable metadata. The untainted data and metadata are stored, and recorded tainted properties for the data and/or metadata are tracked. Input of an analysis request is accepted, and the data is analyzed in the presence of the stored metadata. Copies of imported data and metadata are retained and new versions are created when such data or metadata is mutably updated. Results of the analysis are output. Other embodiments are also disclosed.

### REFERENCE TO PENDING PRIOR PATENT APPLICATION

This application claims the benefit under 35 U.S.C. 119 (e) of U.S. Provisional Patent Application No. 61/954,260, filed Mar. 17, 2014 by John A. De Goes for “SYSTEM AND METHOD FOR THE DATA MANAGEMENT FOR THE ANALYSIS OF DIVERSE, MULTI-STRUCTURED DATA FROM DIVERSE SOURCES TITLE” which patent application is hereby incorporated herein by reference.

### BACKGROUND

Generally, organizations are increasingly faced with the task of analyzing extremely, large, diverse, multi-structured data sets, many of which come from different sources, have differing levels of quality, contain conflicting and missing data, and contain data which may be subject to internal organizational policies, third-party terms of use, industry best practices, or governmental regulations (typically concerning privacy). Such data may be stored and organized in NoSQL (Not only SQL) databases that provide mechanisms for storage and retrieval of data that is modeled in means other than the typical tabular relationships used in relational databases. Such NoSQL databases, such as MongoDB, may be a document-oriented databases designed for storing, retrieving, and managing document-oriented information, also known as semi-structured data.

Analyzing these “big data” data sets results in certain analysis artifacts whose usefulness is hampered by, among other factors the lack of information surrounding how these artifacts were derived, how reliable the artifacts are (given the data that went into creating them), and the terms, policies, and regulations these artifacts are bound by (such as determined by their constituents). Organizations have attempted to deal with these issues by making use of a variety of existing tools (combined with ad hoc, purpose-built solutions), as well as creating business policies that may or may not be followed by personnel. For example, prior solutions would call for having a developer write low-level, one-off code to interact with the NoSQL database to discover the data stored there and answer relevant questions. In another prior solution an organization might develop a workflow to migrate, homogenize, and normalize the data into a Relational Database Management System (RDBMS), with which existing analytic tools may be used. However, the resulting data model does not typically represent the underlying data accurately. Regardless, the result is substantial costs and inefficiencies, regulatory and policy compliance violations that are difficult to detect and correct, a fragility in data management architecture, and an inability to effectively base decisions on the analysis of data due to uncertainties surrounding the usefulness of that data.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In various embodiments, there are provided systems and methods for importing data having existing data specifications from an external system. Any tainted imported data is untainted by ascribing missing properties of the imported data, which are specified in the specification, to the imported data. Properties of resulting untainted data are encoded as composable metadata and the untainted data and composable metadata are stored. Input of analysis is accepted and the stored data is analyzed in the presence of the stored composable metadata. The results of this analysis are then output.

In some embodiments, permissions associated with the data may be enforces. Such enforcement of permissions may be carried out during importation of the data and/or during analysis of the stored data in the presence of the stored composable metadata.

In some additional or further embodiments data policies intrinsic to the data may be enforced. These data policies intrinsic to the data may include policies concerning how long data maybe kept before purging, identity of groups, individuals or systems that have access to which types of data, whether data analysis must be irreversible and/or to what degree, and/or whether data may be stored in encrypted or unencrypted form. The data policies intrinsic to the data may be enforced during storing of the untainted data and composable metadata, and/or during analyzing the stored data in the presence of the stored composable metadata.

In accordance with various embodiments of the present systems and methods, the properties for the imported data that were tainted may be recorded and tracked in stored imported data and/or metadata.

Storing the untainted data and composable metadata may include retaining information on the data pertaining to provenance, lineage, quality, and/or policies and/or retaining information on the untainted data pertaining to information used in data management activities, in some embodiments.

Various embodiments may retain copies of imported data and metadata and creating new versions of such data and metadata when such data or metadata is mutably updated during untainting, encoding, storing and/or analyzing.

Analyzing the stored data in the presence of the stored composable metadata may include data wrangling, historical analytics, predictive analytics, statistical analysis, and/or iterative analyses including optimization analytics and/or machine learning, in some embodiments. Additionally or alternatively, analyzing the stored data in the presence of the stored metadata may include applying NoSQL database query functions. Such NoSQL database query functions may include “find,” “aggregate,” “map/reduce,” and/or the like. Analyzing the stored data in the presence of the stored composable metadata, in some embodiments may further include retaining data properties by creating new updated versions of the stored data for use in the analysis. Further or alternatively, in some embodiments, analyzing the stored data in the presence of the stored metadata may include utilizing stored data and composable metadata as a source and sink for receiving updated data and the updated data associated data management properties.

In various embodiments, one or more of the techniques described herein may be performed by one or more computer systems. In other various embodiments, a tangible computer-readable storage medium may have program instructions stored thereon that, upon execution by one or more computer systems, cause the one or more computer systems to execute one or more operations disclosed herein. In yet other various embodiments, one or more systems may each include at least one processor and memory coupled to the processors, wherein the memory is configured to store program instructions executable by the processor(s) to cause the system(s) to execute one or more operations disclosed herein.

Additional objects, advantages and novel features of the technology will be set forth in part in the description which follows, and in part will become more apparent to those skilled in the art upon examination of the following, or may be learned from practice of the technology.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawings, in which:

FIG. 1 illustrates a schematic representation of an example system configured for management of data for analysis of diverse, multi-structured data from diverse sources, according to some embodiments;

FIG. 2 is a flowchart of an example method for management of data for analysis of diverse, multi-structured data from diverse sources, according to some embodiments; and

FIG. 3 is a block diagram illustrating an example computing device, in which management of data for analysis of diverse, multi-structured data from diverse sources may be implemented, in accordance with some embodiments.

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

Embodiments of the present systems and methods relate generally to the data services field, and more specifically to systems and methods for data management for analysis of diverse, multi-structured data from diverse sources in the information data services field. Such data may be organized into a NoSQL database, such as a document-oriented database, also known as semi-structured database, which may include tainted data, that is, data that is missing some properties such as indications of provenance, lineage, quality, policies, or the like.

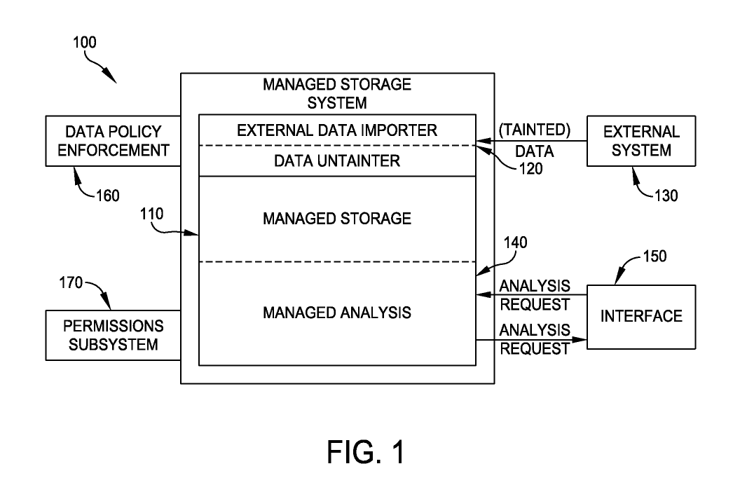

FIG. 1 illustrates a schematic representation of example system 100 configured for management of data for analysis of diverse, multi-structured data from diverse sources, according to some embodiments. Such an embodiment of system 100 for data management may include managed storage subsystem 110 for managed storage of diverse, multi-structured data from diverse data sources. Importation and untainting subsystem 120 imports and untaints tainted data from, by way of example, external system 130, or the like. Managed analysis subsystem 140 performs managed analysis, such as entered via interface 150 provided performing managed data analysis and outputting managed data analysis results. A data policy enforcement subsystem 160 enforces (intrinsic) data policies, in an overall manner, and permissions subsystem 170 enforces (non-intrinsic) data permissions.

Managed storage subsystem 110 functions as a fully managed and access-controlled repository of multi-structured data. In various embodiments, managed storage subsystem 110 retains information on the data pertaining to provenance, lineage, quality, policies, and other information that may be used to effectively support data management activities. In some embodiments, managed storage subsystem 110 provides a managed execution environment for data processing, which provides a substrate of composable (combined) data processing operations. Therein, information pertaining to provenance, lineage, quality, policies and other information useful to effectively support data management activities is automatically tracked and composed (combined), through the execution of such data processing operations. In particular embodiments, managed storage subsystem 110 does not mutably update existing data or metadata, but may create new versions of the data, so that full reproducibility and auditability are preserved.

Importation and untainting subsystem 120 imports and untaints tainted data from external system 130, or the like, in accordance with various embodiments of the present systems and methods, thereby functioning to facilitate importation of external data into managed storage subsystem 110. Tainted data may be generally characterized as data that is missing some properties, which may be useful to effectively support data management activities (including, but not limited to, provenance, lineage, quality and/or policies). Given an existing verified and audited data specification, such as for data in example external system 130, importation and untainting subsystem embodiments imports data from external system 130, and ascribes to the external data any missing properties of the data, such that when the data is fully imported into managed system 100 it contains no data which is tainted. In some embodiments, importation and untainting subsystem 120, or the like, records the data properties that were tainted, so they may be tracked under managed storage system 100.

Interface 150 for performing managed data analysis may function to permit a user or system to enter a request to perform an analysis into data management system 100 for analysis. Interface 150 may take the form of a Graphical User Interface (GUI), via which entry of such an analysis request may be made using Structured Query Language (SQL) or in a similar query format. Further, interface 150 may provide a means of initiating importation of data, such as discussed above, and obtaining the results of the analysis, as discussed below.

Managed analysis subsystem 140 performs managed analysis, such as pursuant to a request entered via interface 150, by facilitating execution of data analysis across diverse, multi-structured data from diverse sources, while keeping track of all properties of data that may be important to data management activities (including, but not limited to, data provenance, lineage, quality, and policies). In various embodiments, managed analysis subsystem 140 may perform generalized data analysis, such as data wrangling, historical analytics, predictive analytics, statistical analysis, and iterative analyses such as optimization analytics and machine learning. Such data analysis may make use of NoSQL database query functions such as “find,” “aggregate,” “map/reduce,” and/or the like. In some embodiments, managed analysis subsystem 140 may utilize managed storage subsystem 110 to perform the analysis, leveraging management of managed storage subsystem 110 data processing facilities to retain information on data properties that may be useful in effectively performing data management. In some other, or further, embodiments, managed analysis subsystem 140 may utilize its own mechanisms for performing managed analysis, while employing managed storage subsystem 110 as a data source and sink for (receiving updated) data and the data's associated data management properties.

Interface 150 for performing managed data analysis may, as well as functioning to permit a user or system to enter a request to perform an analysis, may also provide a means for obtaining output results of the analysis. Such results may include resulting composed properties of the data sources forming a part of the analysis, such as the provenance, lineage, quality, policies, and other composed properties, which may be output to aid in productive, informed, and appropriate use of the analysis results.

Data policy enforcement subsystem 160 may facilitate the overall enforcement of any policies that are intrinsic to, or otherwise related to, the data itself. Such policies may center around how long data maybe kept before purging, which groups, individuals or systems have access to which types of data, whether data analysis should be irreversible (i.e. the original data cannot be reconstructed from the analysis) and to what degree, whether data may be stored in unencrypted form (or if only encrypted), and other types of policies that may be useful to support activities of data management processes. In some embodiments, data policy enforcement subsystem 160 may be integrated into managed storage subsystem 110, or the like. In some other, or further, embodiments, data policy enforcement subsystem 160 may be integrated into managed analysis subsystem 140, or the like. In still other, or still further, embodiments, data policy enforcement subsystem 160 may be a standalone system or subsystem that interacts with and is interacted with by other subsystems of system 100 for data management in an advisory and support role.

Permissions subsystem 170 may function to overall enforce access controls that are not intrinsic to data properties (and thus, may not be required by organizational policies, regulations, industry requirements, and the like). However, such non-intrinsic data properties may be useful to current operational needs of an organization. In various embodiments, permissions subsystem 170 may perform highly granular permission enforcement, including separation of different capabilities such as reading, writing, appending, updating, reducing, and the like, as well as enforcement of time and usage-based expiration of permissions. In some embodiments, permissions subsystem 170 may audit substantially all, or most, changes to permissions. Embodiments of permissions subsystem 170 may integrate with, or delegate to, another permissions systems in an organization making use of data management system 100, such as a Lightweight Directory Access Protocol (LDAP) server, or the like.

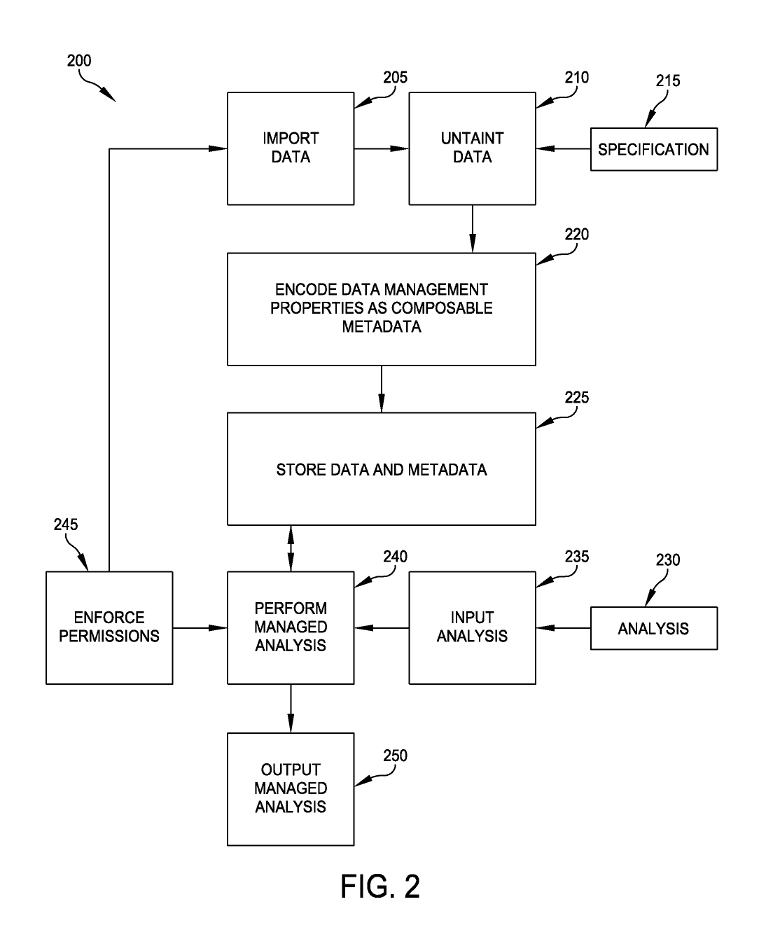

FIG. 2 is a flowchart of example method implementation 200 for management of data for analysis of diverse, multi-structured data from diverse sources, according to some embodiments. As shown in FIG. 2, data management method implementation 200 may include importing (external) data, which may include data from tainted sources, at 205. At 210 tainted data of the data imported at 205 is untainted by supporting the specification of properties of the data such as provenance, lineage, quality, policies, and the like. Such untainting my include, for example ascribing imported (external) data any missing properties of the data, which may be drawn at 215 from an existing verified and audited specification for the imported data. In some embodiments untainting at 210 (or encoding at 220, as discussed below), or the like, may include recording the properties that were tainted, so they may be tracked under embodiments of the present managed storage systems and methods.

At 220 properties of the imported data, such as provenance, lineage, quality, policies, and the like, are encoded as composable metadata (i.e. metadata elements that may be combined to create more complex metadata). The resulting now-untainted, multi-structured data from diverse data sets (including the encoded metadata) is stored at 225 for management as a fully managed and access-controlled repository of multi-structured data. The stored data and metadata may retain information on the data pertaining to provenance, lineage, quality, policies, and other information typically required in order to effectively support data management activities in accordance with various implementations. Further, in accordance with some implementations existing data or metadata is not mutably updated during execution of steps discussed above and below, but rather new versions of the data are created, so that full reproducibility and auditability are preserved, such as through the original versions of the date and any subsequently created versions. Thereby, embodiments of the present systems and methods, provide a managed execution environment for data processing, which provides a substrate of composable data processing operations in which information pertaining to provenance, lineage, quality, policies and other information, which may be used in support of data management activities is automatically tracked and composed through the execution of all such data processing operations.

Analysis 230 is input at 235, such as via an analysis interface (150). Such an interface facilitates managed data analysis by a user or system, allowing entry of request to perform an analysis, and may provides a means of obtaining the results of the analysis, as discussed below.

At 240 managed analysis pursuant to the analysis input at 235 is performed on the stored data in the presence of the stored metadata. This data analysis is thus executed across diverse, multi-structured data from diverse sources, keeping track of all properties of data that are important to data management activities (including, but not limited to, data provenance, lineage, quality, and policies). Such data analysis performed at 240 may include generalized data analysis, such as data wrangling, historical analytics, predictive analytics, statistical analysis, and iterative analyses such as optimization analytics and machine learning. Data analysis at 240 may make use of NoSQL database query functions such as “find,” “aggregate,” “map/reduce,” and/or the like. The data analysis performed at 240 may leverage the management of the stored data to retain information on data properties useful to effectively perform (future) data management of the stored data, such as by not mutably updating existing data or metadata, but by creating new updated versions for use in the analysis. Further, during analysis at 420 the system performing the analysis (i.e. present data management system 100) may in accordance with some embodiments, utilizes its own mechanisms for performing the managed analysis, utilizing the managed storage system as a source and sink for receiving updated data and the data's associated data management properties.

Within various steps of process 200 data policy enforcement may, as noted above, facilitate the enforcement of any policies that may be intrinsic to, or otherwise related to, the data itself, such as: policies concerning how long data maybe kept before purging; which groups or individuals or systems have access to which types of data; whether data analysis must be irreversible (i.e. a requirement that the original data cannot be reconstructed from the analysis) and to what degree; whether data may be stored in unencrypted form (or conversely, whether the data can only be stored in an encrypted form); and other types of policies that may support data management processes and activities. Such data policy enforcement may be a part of storing and maintaining data at 225, the managed analysis performed at 240, or the like.

Overall, method implementation 200 enforces permissions at 245. For example, permissions may be enforced at critical steps where violation of such permissions may be more likely, such as upon the importation (205) of data and during the performance of managed analysis (240). Such permissions functions may include access controls that are not necessarily intrinsic to the data properties (and thus may not be required by organizational policies, regulations, industry requirements, and so forth). However, such access controls may be dictated by, or specified in response to, current operational needs or desires of an organization. These permissions may be highly granular, resulting in separation of different capabilities such as reading, writing, appending, updating, reducing, and the like, and/or may include time and usage-based expiration of permissions. In accordance with various implementation of permissions enforcement at 245 substantially all or most changes to permissions may be audited. Enforcement of permissions at 245 may further include integration with and/or delegation of permission enforcement to other permission systems or processes within the implementing organization, such as an LDAP server.

Managed results of an analysis may be output at 250 such as via the interface discussed above for facilitating managed data analysis by a user or system, allowing entry of request to perform an analysis, and providing a means of obtaining the results of the analysis. These results may include resulting composed properties of the data sources forming a part of the analysis, such as the provenance, lineage, quality, policies, and other composed properties, thereby enabling productive, informed, and accurate use of the analysis results.

As noted, in various embodiments, one or more of the techniques described herein may be performed by one or more computer systems. In other various embodiments, a tangible computer-readable storage medium may have program instructions stored thereon that, upon execution by one or more computer systems, cause the one or more computer systems to execute one or more operations disclosed herein. In yet other various embodiments, one or more systems may each include at least one processor and memory coupled to the processors, wherein the memory is configured to store program instructions executable by the processor(s) to cause the system(s) to execute one or more operations disclosed herein.

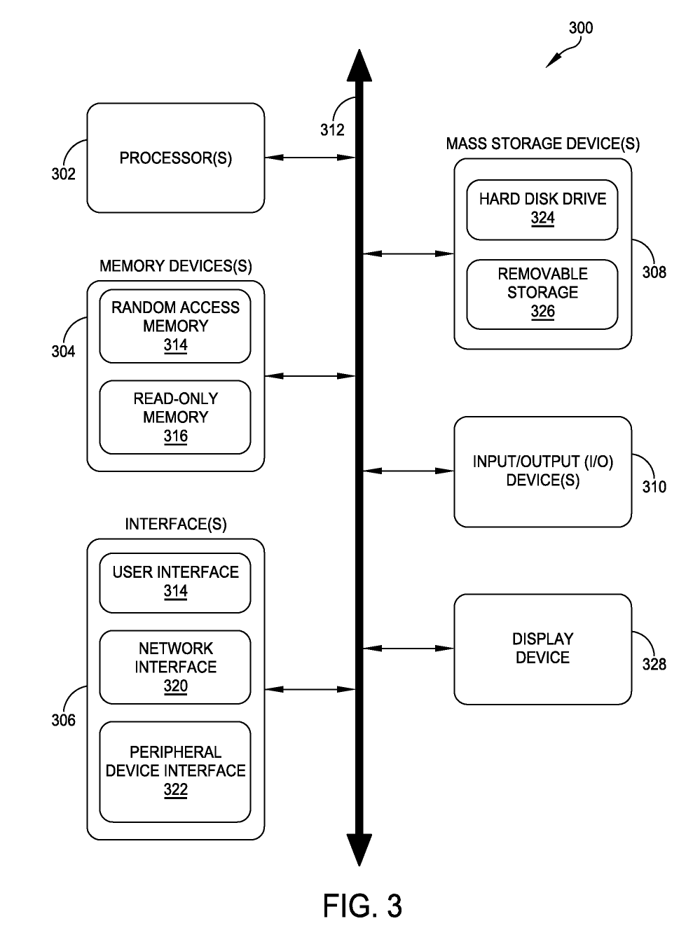

To wit, FIG. 3 is a block diagram, illustrating example computing device 300, in which management of data for analysis of diverse, multi-structured data from diverse sources may be implemented, in accordance with some embodiments and implementations. Hence, computing device 300 may be used to perform various procedures, such as those discussed herein. For example, method 200 may be implemented by a system substantially similar to system 100 described above, but any suitable implementation may alternatively be used. As a further example, computing device 300 can function as a server, a client, a worker node, or any other computing entity, which may make-up system 100 and/or any one of the above described subsystems managed storage subsystem 110 importation and untainting subsystem 120, external system 130, managed analysis subsystem 140, data policy enforcement subsystem 160, permissions subsystem 170, the mentioned LDAP server, and/or the like. Computing device 300 can be any of a wide variety of computing devices, such as a desktop computer, a notebook computer, a server computer, a handheld computer, and the like.

Computing device 300 includes one or more processor(s) 302, one or more memory device(s) 304, one or more interface(s) 306, one or more mass storage device(s) 308, one or more Input/Output (I/O) device(s) 310, and a display device 328 all of which are coupled to a bus 312. Processor(s) 302 include one or more processors or controllers that execute instructions stored in memory device(s) 304 and/or mass storage device(s) 308. Processor(s) 302 may also include various types of computer-readable media, such as cache memory.

Memory device(s) 304 include various computer-readable media, such as volatile memory (e.g., random access memory (RAM)) 314 and/or nonvolatile memory (e.g., read-only memory (ROM) 316). Memory device(s) 304 may also include rewritable ROM, such as Flash memory.

Mass storage device(s) 308 include various computer readable media, such as magnetic tapes, magnetic disks, optical disks, solid state memory (e.g., Flash memory), and the like. As shown in FIG. 3, a particular mass storage device is a hard disk drive 324. Various drives may also be included in mass storage device(s) 308 to enable reading from and/or writing to the various computer readable media. Mass storage device(s) 308 include removable media 326 and/or non-removable media.

I/O device(s) 310 include various devices that allow data and/or other information to be input to or retrieved from computing device 300. Example I/O device(s) 310 include cursor control devices, keyboards, keypads, microphones, monitors or other display devices, speakers, printers, network interface cards, modems, lenses, CCDs or other image capture devices, and the like.

Display device—is optionally directly coupled to the computing device 300. If display device 328 is not coupled to device 300 such a device is operatively coupled to another device that is operatively coupled to device 300 and accessible by a user of the results of method 200, or the like such as via interface 150. Display device 328 includes any type of device capable of displaying information to one or more users of computing device 300. Examples of display device 328 include a monitor, display terminal, video projection device, and the like.

Interface(s) 306 include various interfaces that allow computing device 300 to interact with other systems, devices, or computing environments. Example interface(s) 306 include any number of different network interfaces 320, such as interfaces to local area networks (LANs), wide area networks (WANs), wireless networks, and the Internet. Other interfaces include user interface 318 and peripheral device interface 322.

Bus 312 allows processor(s) 302, memory device(s) 304, interface(s) 306, mass storage device(s) 308, and I/O device(s) 310 to communicate with one another, as well as other devices or components coupled to bus 312. Bus 312 represents one or more of several types of bus structures, such as a system bus, PCI bus, IEEE 1394 bus, USB bus, and the like.

For purposes of illustration, programs and other executable program components are shown herein as discrete blocks, although it is understood that such programs and components may reside at various times in different storage components of computing device 300, and are executed by processor(s) 302. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. A method comprising:
importing data having existing data specifications from an external system;
untainting any tainted imported data by ascribing missing properties of the imported data specified in the specification to the imported data;
encoding properties of resulting untainted data as composable metadata;
storing the untainted data and composable metadata;
accepting input of analysis;
analyzing stored data in the presence of stored composable metadata; and
outputting results of the analyzing.

2. The method of claim 1, further comprising enforcing permissions associated with the data.

3. The method of claim 2, wherein enforcing permissions associated with the data further comprises enforcing permissions associated with the data during importing the data and/or enforcing permissions associated with the data during analyzing the stored data in the presence of the stored composable metadata.

4. The method of claim 1, further comprising enforcing data policies intrinsic to the data.

5. The method of claim 4, wherein data policies intrinsic to the data include policies concerning how long data maybe kept before purging, identity of groups, individuals or systems that have access to which types of data, whether data analysis must be irreversible and/or to what degree, and/or whether data may be stored in encrypted or unencrypted form.

6. The method of claim 4, wherein enforcing data policies intrinsic to the data include enforcing data policy intrinsic to the data during storing of the untainted data and composable metadata and/or during analyzing the stored data in the presence of the stored composable metadata.

7. The method of claim 1, further comprising:
recording the properties for the imported data that were tainted; and
tracking recorded tainted properties for the imported data in stored imported data and/or metadata.

8. The method of claim 1 wherein storing the untainted data and composable metadata further comprises retaining information on the data pertaining to provenance, lineage, quality, and/or policies and/or retaining information on the untainted data pertaining to information used in data management activities.

9. The method of claim 1, further comprising retaining copies of imported data and metadata and creating new versions of such data and metadata when such data or metadata is mutably updated during the untainting, the encoding, the storing and/or the analyzing.

10. The method of claim 1, wherein analyzing the stored data in the presence of the stored composable metadata includes data wrangling, historical analytics, predictive analytics, statistical analysis, and/or iterative analyses including optimization analytics and/or machine learning.

11. The method of claim 1, wherein analyzing the stored data in the presence of the stored metadata includes applying NoSQL database query functions.

12. The method of claim 11, wherein the NoSQL database query functions include find, aggregate, and/or map/reduce.

13. The method of claim 1, wherein analyzing the stored data in the presence of the stored composable metadata further comprises retaining data properties by creating new updated versions of the stored data for use in the analysis.

14. The method of claim 1, wherein analyzing the stored data in the presence of the stored metadata further comprises utilizing stored data and composable metadata as a source and sink for receiving updated data and the updated data associated data management properties.

15. A tangible computer-readable storage medium may have program instructions stored thereon that, upon execution by one or more computer systems, cause the one or more computer systems to:
import data having existing data specifications from an external system;
untaint any tainted imported data by ascribing missing properties of the imported data specified in the specification to the imported data;
encode properties of resulting untainted data as composable metadata;
store the untainted data and composable metadata;
accept input of an analysis request;
analyze stored data in the presence of stored composable metadata; and
output results of analyzing the stored data in the presence of stored composable metadata.

16. The tangible computer-readable storage medium of claim 15, wherein the program instructions, upon execution, cause the one or more computer systems to enforce permissions associated with the data.

17. The tangible computer-readable storage medium of claim 15, wherein the program instructions, upon execution, cause the one or more computer systems to enforce data policies intrinsic to the data.

18. The tangible computer-readable storage medium of claim 15, wherein the program instructions, upon execution, cause the one or more computer systems to:
record the properties for the imported data that were tainted; and
track recorded tainted properties for the imported data in stored imported data and/or metadata.

19. The tangible computer-readable storage medium of claim 15, wherein the program instructions, upon execution, cause the one or more computer systems to retain copies of imported data and metadata and creating new versions of such data and metadata when such data or metadata is mutably updated during untainting, encoding, storing and/or analyzing.

20. A system for management of data for analysis of diverse, multi-structured data from diverse sources comprising one or more subsystems which may each include at least one processor and memory coupled to the at least one processors, wherein the memory is configured to store program instructions executable by the at least one processors to cause the system to:
import data having existing data specifications from an external system;
enforce permissions associated with the imported data;
enforce data policies intrinsic to the imported data;
untaint any tainted imported data by ascribing missing properties of the imported data specified in the specification to the imported data;
record the properties for the imported data that were tainted;
encode properties of resulting untainted data as composable metadata;
store the untainted data and composable metadata;
track recorded tainted properties for the imported data in stored imported data and/or metadata;
accept input of an analysis request;
analyze stored data in the presence of stored composable metadata;
retain copies of imported data and metadata and creating new versions of such data and metadata when such data or metadata is mutably updated during untainting, encoding, storing and/or analyzing; and
output results of the analyzing.
